(19) United States
(12) Patent Application Publication
(10) Pub. No.: US 2004/0049611 A1
(43) Pub. Date: Mar. 11, 2004

(54) Flexible serial port configuration and method

(75) Inventors: Daniel B. Kotlow, Cherry Hill, NJ (US); John J. Mahon, Framingham, MA (US)

Correspondence Address: RINES AND RINES, ATTORNEYS AT LAW, 81 North State Street, Concord, NH, 03301, US

(73) Assignee: MicroLogic, Inc.

(21) Appl. No.: 10/237,335

(22) Filed: Sep. 7, 2002

(51) Int. Cl. G06F 3/00

(52) U.S. Cl. 710/38

(57) ABSTRACT

Flexible serial communication switching system and technique for serially connecting peripheral devices with a microprocessor, and with accommodation for switching either for substitute communicating with an external auxiliary device when connected to the microprocessor port, or to permit the auxiliary device directly serially to communicate with a peripheral device, and with the microprocessor being informed as to which switching mode automatically to assume.

### FIELD

This invention relates to microprocessor-based system communication with preferred devices through standard serial connectors such as of the RS232C type and the like, and wherein communication may also be required with auxiliary devices such as standard laptop or handheld computers plugged into a port of the microprocessor, as for such purposes as maintenance or the like; the invention being more particularly concerned with the switching of the processor communication connections between the peripheral device and the auxiliary device upon such plug-in, and switching back upon disconnect thereof, and with the flexible requirement of processor knowledge as to which switching mode to be in.

### BACKGROUND

The problem of flexibly switching the microprocessor communication between multiple devices as different devices are plugged in or disconnected from the microprocessor and with a priori knowledge provided as to which switching mode is to be used by the microprocessor, is admirably addressed by the present invention and for satisfying two sets of application requirements.

In the first application, the microprocessor normally communicates with a peripheral device via a standard RS 232 C serial connection as before mentioned; but at any time, a technician may plug a standard laptop or handheld computer or the like into a port of the microprocessor to conduct maintenance operations, at which time the microprocessor must notice the presence of the plugged-in device and switch over to communicating with it. When, moreover, the plugged-in device is disconnected, the microprocessor must notice its absence, also distinguishing it from just silence, and switch back to communicating with the peripheral device.

In the second application, the microprocessor does not communicate at all, but the technician may plug-in for the purpose of communicating directly with a peripheral device. In such event, the microprocessor must not intervene in their communication, but must notice the presence (e.g. for security reasons).

The principal aim of this invention is to meet these two requirements with a minimum of physical resources.

### OBJECTS OF INVENTION

A primary object of the invention, accordingly, is to provide a new and improved method of and apparatus for enabling such multi-application flexible serial communication with peripheral devices by a microprocessor or the like, and with flexible accommodation for automatically switching either to communicate with a plugged-in auxiliary device when connected to a microprocessor port and then back to communicate with the peripheral device upon unplugging the auxiliary device, or to permit the auxiliary device directly to communicate with a peripheral device; and with the microprocessor knowing or being informed as to which switching mode to assume.

A further object is to provide such a novel flexible serial port-switching configuration that requires only a minimum of physical resources.

Other and further objects will be explained hereinafter and are more particularly defined in the appended claims.

### SUMMARY

In summary, from one of its viewpoints, the invention embraces a method of enabling flexible switching of serial port communication amongst a microprocessor, an external peripheral device and an external auxiliary device optionally pluggable into the microprocessor and disconnectable therefrom for such purposes as maintenance, the method comprising, serially connecting the microprocessor to communicate with a peripheral device; upon the plugging into the microprocessor of an external auxiliary device, indicating such at the microprocessor and automatically effecting switching of the serial port communication with the microprocessor from the peripheral device to the auxiliary device; switching back to communication between the peripheral device and the microprocessor upon indication of the unplugging of the auxiliary device; indicating to the microprocessor when it is desired to establish serial port communication between the auxiliary device and the peripheral device, and thereupon automatically switching to serial port connection between the auxiliary device and the peripheral device and without involving communication with the microprocessor.

Preferred and best mode designs and configurations are later detailed.

### DRAWINGS

The invention will now be explained in connection with the accompanying drawings,

FIG. 1 of which is a combined block and schematic circuit diagram illustrating a preferred implementation of the invention;

FIG. 2 is a modification of FIG. 1 which illustrates the signal paths implemented when the microprocessor communicates with a peripheral device;

FIG. 3 is a modification of FIG. 1 which illustrates the signal paths and connections implemented when an auxiliary device is connected to a later-explained header H1 and communicates with the microprocessor; and

FIG. 4 is a further modification of FIG. 1 illustrating the signal paths and connections implemented when an auxiliary device is connected to a later-explained header H2 and communicates directly with a peripheral device.

### DESCRIPTION OF PREFERRED EMBODIMENT OF INVENTION

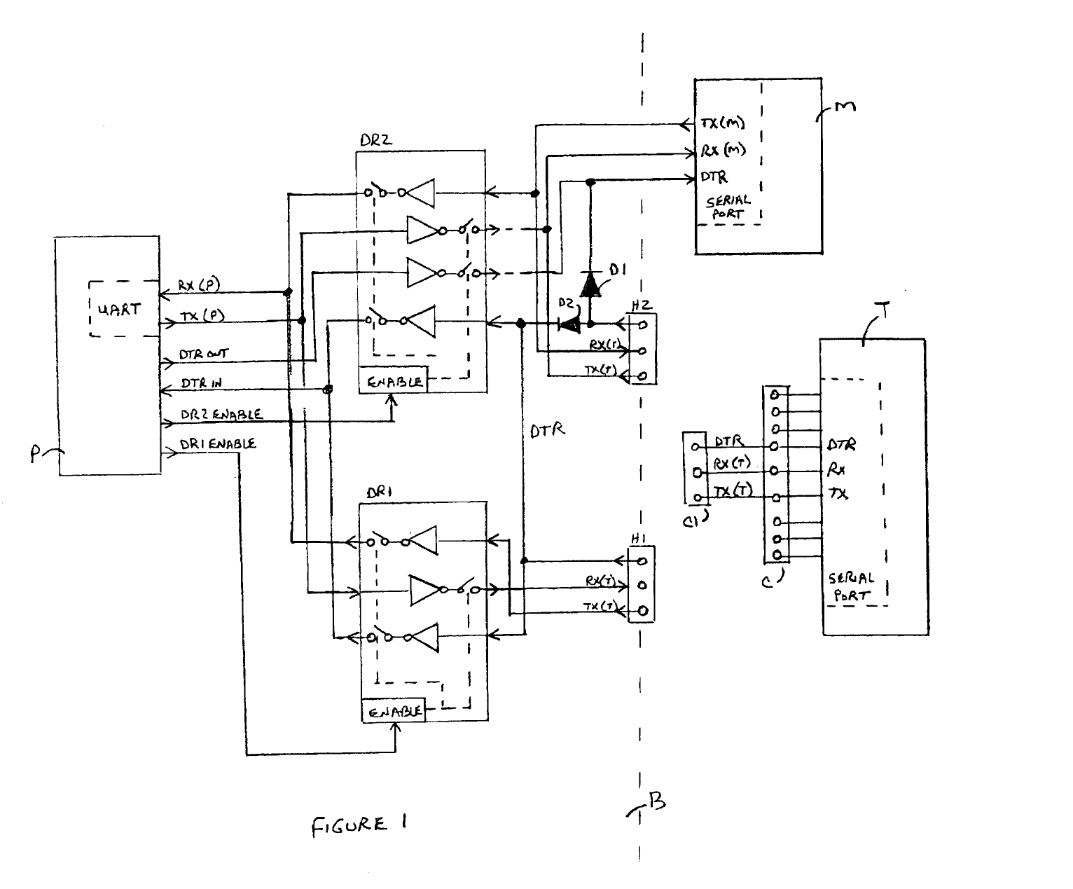

Referring to FIG. 1, the microprocessor-based housing is shown at B serially connectable to communicate with either an external peripheral device M or a plugged-in external auxiliary device such as a maintenance technician's handheld computer T, as previously described.

The invention entails, in preferred form, implementing a microprocessor P with a single on-chip UART (Universal Asynchronous Receiver/Transmitter)—the facility that enables it to conduct serial communications, and providing, for example, one 9-pin standard PC serial port connector C, and contriving to share these facilities as follows.

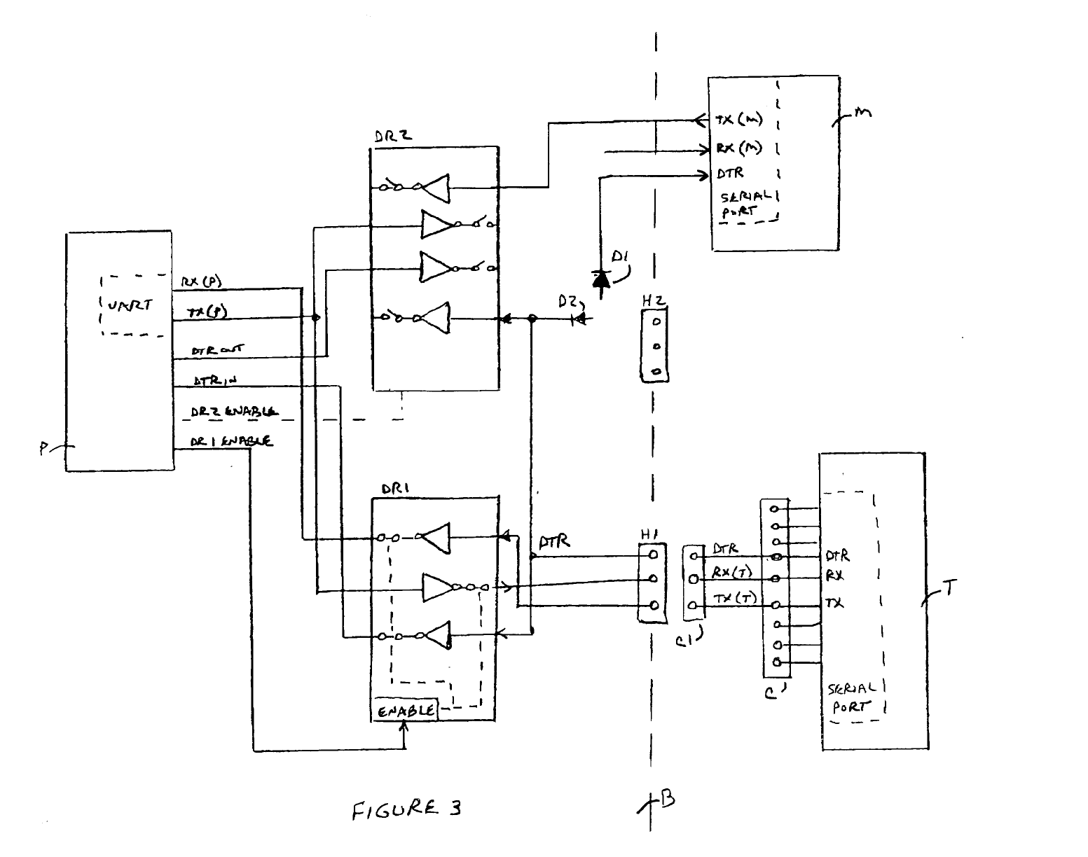

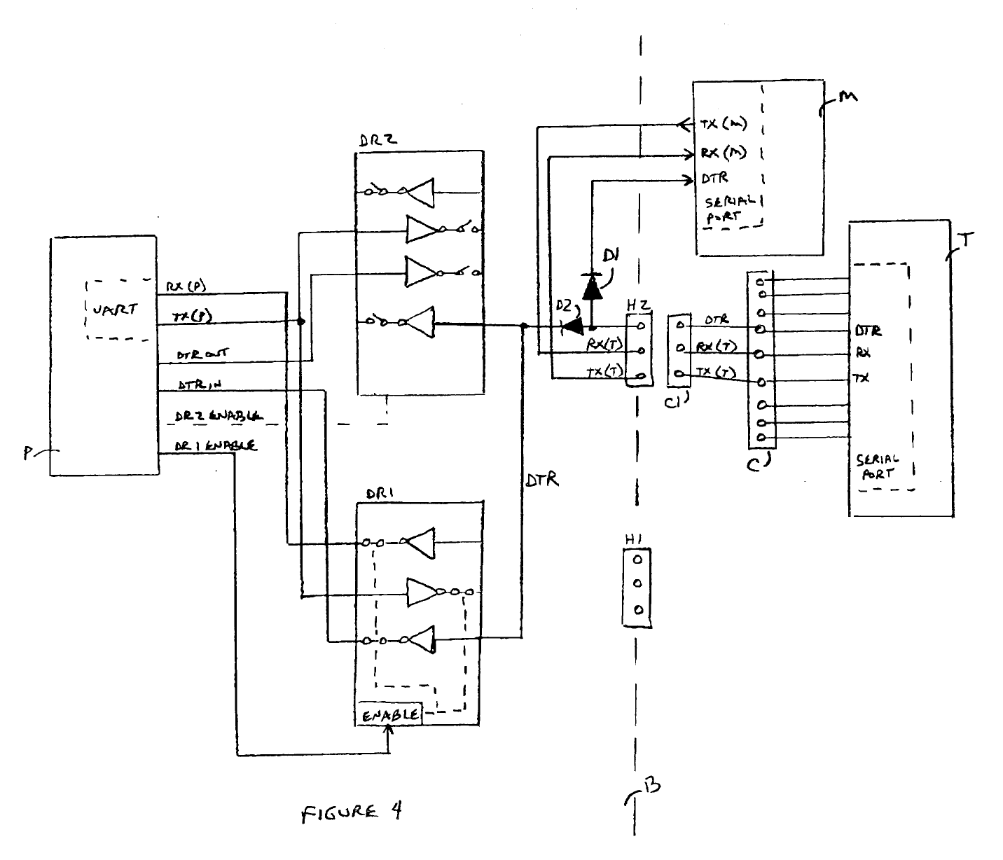

Two headers, H1 and H2, are provided on the microprocessor PC board. The serial port connector C is wired through a connector C1, which can be placed on H1 as shown in FIG. 3 for the first application, and on H2 as shown in FIG. 4 for the second application above described.

Two RS232 driver/receiver chips DR1 and DR2 are also provided, each with two drivers and two receivers. The two drivers can be enabled and disabled by the microprocessor (as labeled). The two receivers (independently of the drivers) are similarly enabled and disabled, as labeled. The presence of an auxiliary device T is automatically indicated by the assertion of the Data Terminal Ready (DTR) signal on the hand-held computer's serial port.

One driver input from each of DR1 and DR2 is connected (wired) to the microprocessor transmit data output (TX DATA). Likewise, one receiver output from each is connected to the microprocessor receiver data input (RX DATA). The microprocessor sees to it that only one of the drivers and only one of the receivers is enabled at any given time, avoiding conflicts. The data signals of DR2 are wired to the data pins of the peripheral device M, and the data signals of DR1 are wired to the data pins of the auxiliary device T through H1. The processor can then exchange data with the peripheral device M through DR2 and with the auxiliary device T, through DR1. The other of the DR2 drivers is used to assert the DTR signal to the peripheral device M when the microprocessor P is communicating with it.

As shown in FIG. 4, a pin on H2 is connected to the DTR output pin of the serial port of the auxiliary device T and, through diode D1 to the DTR input of the peripheral device M and to the second (DTR) driver on DR1, and through diode D2 to (DTR) receivers on DR1 and DR2. The data pins of the serial port of the auxiliary device T are wired through H2 to those of the peripheral device M. This arrangement enables the auxiliary device T to assert DTR to the peripheral device M and to be automatically noticed by the microprocessor on DR1, and thereby meet the requirements of the second application before discussed. DR2 is never enabled in this application, so there is no conflict with H2. The diodes prevent the DTR driver on DR2 from driving the DR1 DTR receiver (or that of DR2, which shares a common connection with DR1).

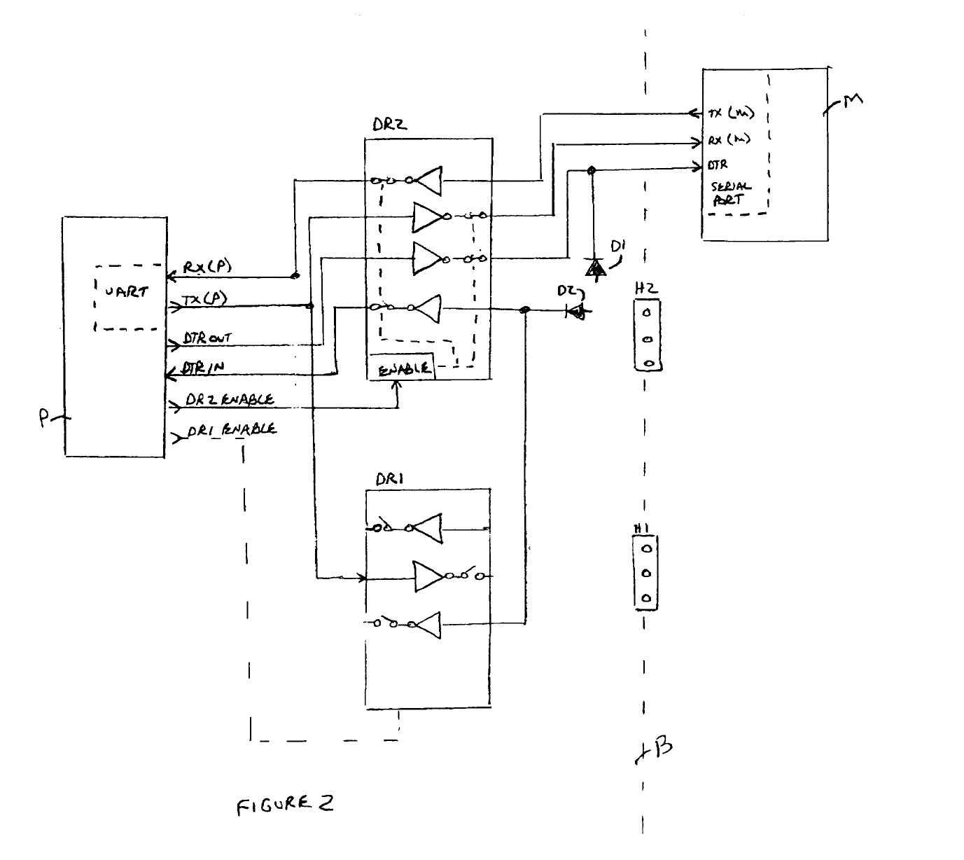

Since the pin on H1 connected to the DTR of the auxiliary device T is wired to receivers on both DR1 and DR2, the microprocessor P can then “see” the auxiliary device DTR signal, whichever of DR1 and DR2 it may be using at a given moment. As shown in FIG. 2, the diode D1 allows the DR2 DTR driver to drive the DTR input of the peripheral device M without interfering with the auxiliary device DTR output; while FIG. 3 shows that diode D2 allows auxiliary device T to assert DTR to DR1 and DR2 through H1 without interfering with the microprocessor DTR output to peripheral device M. This, therefore, serves to meet the requirements of the first application previously explained.

The headers H1 and H2 in the figure, moreover, may either be headers that, as before-described, allow a single case-mounted standard serial connector to be moved between the two serial I/O circuits on the microprocessor PC board, or they may be case-mounted serial connectors, allowing the technician's auxiliary device T to connect to either of the serial I/O circuits on the microprocessor PC board without the need to open the housing or physically move an internal connector.

In addition to the two application requirements previously described, moreover, that underlie the invention, the circuit of the invention also solves another problem. The microprocessor P normally communicates with the peripheral device M via a standard RS2332 serial connection as earlier stated. But the technician with the auxiliary device T must be able to plug a standard computer into one of two ports of the microprocessor P to communicate; for example, to conduct maintenance operations directly with either microprocessor P, as shown in FIG. 3, or the peripheral device M, as shown in FIG. 4.

In the solution provided by the invention, connecting T to either of the headers (which in this case could take the form of the previously mentioned 9-pin standard PC serial port connectors) will cause the microprocessor P to “see” DTR, suspend communications with the peripheral device M (disabling driver DR2), and prepare to communicate with the auxiliary device T (enabling driver DR1).

When the auxiliary device T is connected to header H1, the microprocessor P and the auxiliary device T can communicate; and when the auxiliary device T is connected to header H2, the peripheral device M and the auxiliary device T can communicate. Since the microprocessor P has disabled DR2, it will not cause any conflict. In such case, the microprocessor P could continue other programmed functionality while periodically polling to see if the auxiliary device T is attempting to initiate communications through header H1—since microprocessor P cannot otherwise determine to which header the auxiliary device T has connected.

When the auxiliary device T is disconnected or unplugged, and its connection to the microprocessor terminated, moreover, the microprocessor P detects the loss of DTR and returns to communicating with the peripheral device M, disabling driver DR1 and enabling driver DR2.

Further modifications will also occur to those skilled in this art, and such are considered to fall within the spirit and scope of the invention as defined in the appended claims.

What is claimed is:

1. A method of enabling flexible switching of serial port communication amongst a microprocessor, an external peripheral device, and an external auxiliary device optionally pluggable into the microprocessor and disconnectable therefrom for such purposes as maintenance, the method comprising, serially connecting the microprocessor to communicate through said port with a peripheral device; upon the plugging into the microprocessor port of an external auxiliary device, indicating such at the microprocessor and automatically effecting switching of the serial port communication with the microprocessor from the peripheral device to the auxiliary device; automatically switching back to communication between the peripheral device and the microprocessor upon indication of the unplugging of the auxiliary device; indicating to the microprocessor when it is desired to establish direct serial port communication between the auxiliary device and the peripheral device; and thereupon automatically switching to serial port connection between the auxiliary device and the peripheral device and without involving communication with the microprocessor.

2. The method of claim 1 wherein said indicating is effected by asserting data terminal ready signals at the serial port.

3. The method of claim 2 wherein the data terminal ready signals enable the microprocessor to exchange data with the peripheral device, and separately with the auxiliary device, and with a data ready signal asserted to the peripheral device when the microprocessor is communicating with it.

4. The method of claim 3 wherein the auxiliary device asserts a terminal ready signal to the peripheral device with notifying indication to the microprocessor.

5. A method of enabling multi-application flexible serial port communication with peripheral devices by a microprocessor that comprises, flexibly accommodating switching so as in one mode to disconnect communication through said port with such a peripheral device responsive to the connection of an auxiliary device into the microprocessor port so as to establish communication between the microprocessor and the auxiliary device, and to re-connect communication with said peripheral device upon disconnection of the auxiliary device from said port; and, in another mode, switching such auxiliary device directly to communicate with said peripheral device through said port, when desired, without involving communication with the microprocessor; and automatically informing the microprocessor upon and by each such connection and disconnection as to which switching mode to assume.

6. The method of claim 5 wherein separate terminal ready signals are asserted to control the exchange of data between the microprocessor and the peripheral device, between the microprocessor and the auxiliary device, and between the auxiliary device and the peripheral device.

7. The method of claim 6 wherein such terminal ready signals provide the control of which switching mode the microprocessor assumes.

8. A flexible serial port configuration apparatus for enabling flexible switching of serial port communication amongst a microprocessor, an external peripheral device, and an external auxiliary device optionally pluggable into the microprocessor and disconnectable therefrom for such purposes as maintenance, the apparatus having, in combination, a microprocessor port for serially connecting the microprocessor to communicate with a peripheral device; upon the plugging into the microprocessor port of an external auxiliary device, means responsive to such plug-in at the microprocessor for effecting switching of the serial port communication with the microprocessor from the peripheral device to the auxiliary device through said port; means responsive to the unplugging of the auxiliary device for switching back to communication through said port between the peripheral device and the microprocessor; and means for indicating to the microprocessor when direct serial port communication between the auxiliary device and the peripheral device is desired; and means thereupon operable for switching to serial port connection between the auxiliary device and the peripheral device and without requiring communication with the microprocessor.

9. The flexible, serial port configuration apparatus of claim 8 wherein means is provided for automatically notifying the microprocessor as to which switching mode to assume.

10. The flexible serial port configuration apparatus of claim 9 wherein the notifying means comprises terminal ready signal-producing chips enabling signal assertion to control the exchange of data between the microprocessor and the peripheral device, between the microprocessor and the auxiliary device, and between the auxiliary device and the peripheral device.

11. A flexible serial port data communication switching system for selectively serially connecting peripheral and external auxiliary devices with a microprocessor and to one another, the system having, in combination, multi-mode switching means for enabling, in one mode, serial port communication between the microprocessor and an external auxiliary device upon its connection to the microprocessor port, and automatically switching back to the peripheral device upon disconnection of the auxiliary device from the microprocessor port; and, in another mode, for switching the auxiliary device directly serially to communicate with the peripheral device; and signal means controlled by the connections at the serial port for automatically informing the microprocessor as to which switching mode to assume.
